(19) United States
(12) Patent Application Publication
(10) Pub. No.: US 2013/0291365 A1
(43) Pub. Date: Nov. 7, 2013

(54) ACCESSORY MOUNTING SYSTEM

(71) Applicants: Wayne Scott Hoofnagle, Redmond, WA (US); William H. BURKE, Shoreline, WA (US); Kevin Pearce, Everett, WA (US)

(72) Inventors: Wayne Scott Hoofnagle, Redmond, WA (US); William H. BURKE, Shoreline, WA (US); Kevin Pearce, Everett, WA (US)

(73) Assignee: FLUKE CORPORATION, Everett, WA (US)

(21) Appl. No.: 13/463,178

(22) Filed: May 3, 2012

(51) Int. Cl. F16B 1/00; B23P 11/00

(52) U.S. Cl. 29/464; 403/27

(57) ABSTRACT

A system, apparatus and method for providing anti-rotation to an accessory for a network test instrument or the like, includes a threaded insert mounted in the test instrument, an anti-rotation feature receiving opening, and corresponding threaded fastener and anti-rotation mounting stud on the accessory, whereby engagement between the features ensures proper alignment and prevents rotation of the mounted accessory.

### BACKGROUND OF THE INVENTION

In network test instruments and other situations, a test instrument may have optional accessories that mount to the outside of the test instrument case. Providing a secure mount to the case can be problematic. Proper orientation of the accessory may be important also, so it is desirable to have some means to ensure correct orientation.

### SUMMARY OF THE INVENTION

In accordance with the invention, an improved method and apparatus is provided for accessory mounting. A threaded insert is provided in conjunction with an anti-rotation element, providing a unitary attachment device.

Accordingly, it is an object of the present invention to provide an improved accessory mounting system.

It is a further object of the present invention to provide an improved method and apparatus for mounting accessory items to a test instrument.

It is yet another object of the present invention to provide an improved device and method for providing an accessory mount.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of an accessory mount in accordance with the present disclosure; and

FIG. 2 is an illustration of a test instrument with corresponding mounting elements to mate with the accessory mount of FIG. 1.

### DETAILED DESCRIPTION

The system according to a preferred embodiment of the present invention comprises a system and method for mounting accessories to a device, for example a test instrument.

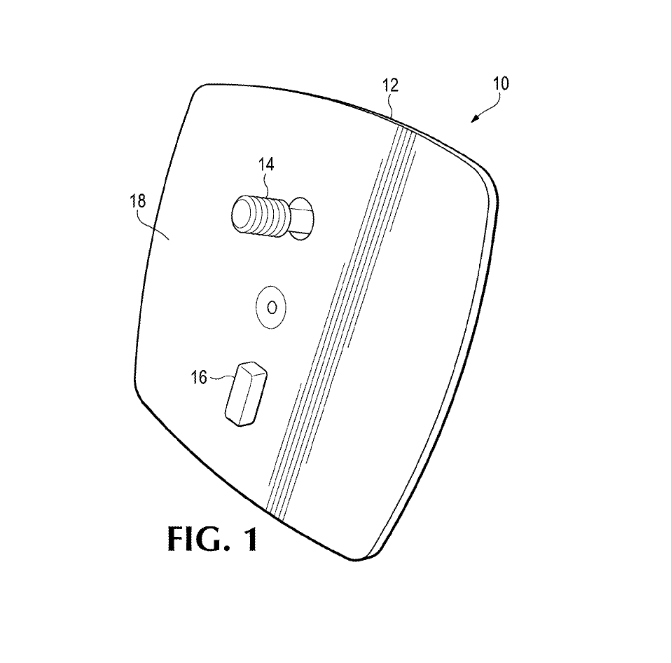

Referring to FIG. 1, a view of an accessory employing the mounting system of the present disclosure, the accessory 10 includes a substantially planar mounting base 12 which has the accessory 10 mounted on the back thereof. The mounting base 12 includes a screw member 14 positioned approximately centrally of the base on a left to right basis and approximately ¼ to ⅓ of the way in from an edge on a top to bottom basis. The screw is rotatably mounted such that it can be rotated by access from the opposite end of the screw (not visible in FIG. 1)

An anti-rotation feature 16 is positioned on the accessory, in the form of a protruding rectangular stud which extends a distance above the back face plane 18 of the accessory.

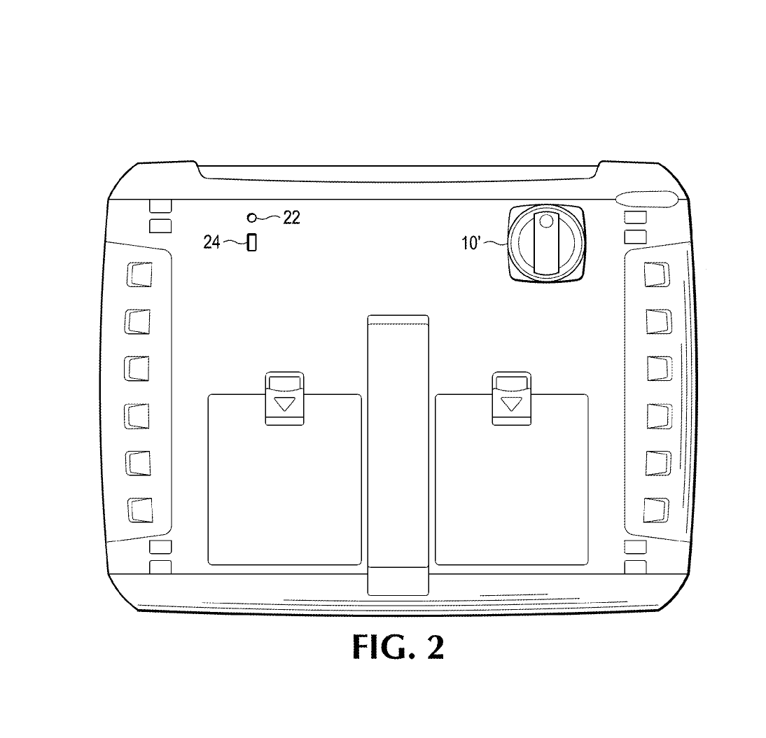

Referring to FIG. 2, an illustration of a test instrument 20, in this example, the back face of the test instrument, a threaded fastener hole 22 provided in the form of a threaded insert, is adapted to receive screw 14 therein, and an anti-rotation feature receiving opening 24 is further formed in the test instrument, of shape and size to receive anti-rotation feature 16 therein, to provide a insertion/removal fit which is suitably snug enough to prevent rotation of the accessory once the anti-rotation feature 16 and opening 24 are mated.

The particular test instrument 20 illustrated in FIG. 2 is configured to receive up to 2 accessories, with left and right side accessory mounting features, wherein a particular accessory 10′, an external antenna, is shown mounted on the right hand side mounting position.

While the preferred embodiment employs the male portions of the threaded fastener and anti-rotation feature on the accessory, variations are possible wherein the male and female portions can be on either the test instrument or the accessory, either both male/both female or alternating male/female male/female.

The system provides a manner to ensure against rotation of a mounted accessory, and can also function to ensure proper alignment of a particular accessory when such alignment may be important to the proper functioning of the accessory.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A mounting system for attaching an accessory to a network test instrument, comprising:
a fastener receiving portion on the test instrument;
an anti-rotation feature on the test instrument;
a fastener portion on the accessory for corresponding engagement with the fastener receiving portion; and
a second anti-rotation feature corresponding to the alignment feature on the instrument for ensuring proper alignment of the accessory relative to the test instrument.

2. A mounting system for attaching an accessory to a network test instrument according to claim 1, wherein said fastener receiving portion on the test instrument comprises a threaded insert.

3. A mounting system for attaching an accessory to a network test instrument according to claim 1, wherein said anti-rotation feature on the test instrument comprises an opening adapted for receiving a corresponding other anti-rotation feature.

4. A mounting system for attaching an accessory to a network test instrument according to claim 1, wherein said fastener portion on the accessory for corresponding engagement with the fastener receiving portion comprises a threaded member.

5. A mounting system for attaching an accessory to a network test instrument according to claim 4, wherein said fastener portion on the accessory further provides for correct accessory alignment.

6. A mounting system for attaching an accessory to a network test instrument according to claim 1, wherein said second anti-rotation feature corresponding to the alignment feature on the instrument for ensuring proper alignment of the accessory relative to the test instrument comprises a raised member extending above a portion of the accessory.

7. A mounting system for attaching an accessory to a network test instrument according to claim 5, wherein said second anti-rotation feature corresponding to the alignment feature on the instrument for ensuring proper alignment of the accessory relative to the test instrument further provides for correct accessory alignment.

8. A method for attaching an accessory to a network test instrument, comprising:
providing a fastener receiving portion on the test instrument;
providing an anti-rotation feature on the test instrument;
providing a fastener portion on the accessory for corresponding engagement with the fastener receiving portion; and
providing a second anti-rotation feature corresponding to the alignment feature on the instrument for ensuring proper alignment of the accessory relative to the test instrument.

9. The method according to claim 8, wherein said providing a fastener receiving portion on the test instrument comprises providing a threaded insert.

10. The method according to claim 8, wherein said providing an anti-rotation feature on the test instrument comprises an opening adapted for receiving a corresponding other anti-rotation feature.

11. The method according to claim 8, wherein said providing a fastener portion on the accessory for corresponding engagement with the fastener receiving portion comprises a threaded member.

12. The method according to claim 11, wherein said fastener portion on the accessory further provides for correct accessory alignment.

13. The method according to claim 8, wherein said providing said second anti-rotation feature corresponding to the alignment feature on the instrument for ensuring proper alignment of the accessory relative to the test instrument comprises a providing raised member extending above a portion of the accessory.

14. The method according to claim 13, wherein said second anti-rotation feature corresponding to the alignment feature on the instrument for ensuring proper alignment of the accessory relative to the test instrument further provides for correct accessory alignment.

15. A test instrument for network testing, comprising:
a fastener receiving portion on the test instrument;
an anti-rotation feature on the test instrument;
a fastener portion on the accessory for corresponding engagement with the fastener receiving portion; and
a second anti-rotation feature corresponding to the alignment feature on the instrument for ensuring proper alignment of the accessory relative to the test instrument.

16. A test instrument according to claim 15, wherein said fastener receiving portion on the test instrument comprises a threaded insert.

17. A test instrument according to claim 15, wherein said anti-rotation feature on the test instrument comprises an opening adapted for receiving a corresponding other anti-rotation feature.

18. A test instrument according to claim 15, wherein said fastener portion on the accessory for corresponding engagement with the fastener receiving portion comprises a threaded member.

19. A test instrument according to claim 15, wherein said second anti-rotation feature corresponding to the alignment feature on the instrument for ensuring proper alignment of the accessory relative to the test instrument comprises a raised member extending above a portion of the accessory.

20. A test instrument according to claim 19, wherein said second anti-rotation feature corresponding to the alignment feature on the instrument for ensuring proper alignment of the accessory relative to the test instrument further provides for correct accessory alignment.
